(19) United States
(12) Patent Application Publication
(10) Pub. No.: US 2017/0106857 A1
(43) Pub. Date: Apr. 20, 2017

(54) VEHICLE COLLISION SYSTEM AND METHOD OF USING THE SAME

(71) Applicant: GM GLOBAL TECHNOLOGY OPERATIONS LLC, Detroit, MI (US)

(72) Inventors: Mohamed M. Nasser, Dearborn, MI (US); Steve K. Dobos, Lapeer, MI (US); Jerry D. Green, Ortonville, MI (US); Fred W. Huntzicker, Ann Arbor, MI (US); Joshua R. Auden, Brighton, MI (US)

(21) Appl. No.: 14/918,232

(22) Filed: Oct. 20, 2015

(51) Int. Cl. B60W 30/09

(52) U.S. Cl. CPC B60W 30/09; B60W 2550/10

(57) ABSTRACT

A method is provided for use with a vehicle collision system. The method includes identifying one or more objects along a side surface of the vehicle, determining a highest threat object based on the vehicle's trajectory relative to the one or more identified objects, calculating a time-to-collision between the highest threat object and the side surface of the vehicle, determining a remedial action by comparing the time-to-collision with at least one threshold, and initiating the remedial action to avoid a collision between the side surface of the vehicle and the highest threat object.

### FIELD

The present invention generally relates to vehicle collision systems, and more particularly, to a vehicle collision system configured to detect and mitigate side object collisions.

### BACKGROUND

Traditional vehicle collision systems are used to warn or otherwise alert a driver of a potential collision with an object or another vehicle. However, these warning systems are typically limited to other vehicles or objects in a forward or reverse host vehicle trajectory. Objects or other vehicles that pose a collision threat to the sides of a vehicle are generally difficult to detect, especially in low speed scenarios such as parking or turning corners.

### SUMMARY

According to an embodiment of the invention, there is provided a method for use with a vehicle collision system. The method includes identifying one or more objects along a side surface of the vehicle, determining a highest threat object based on the vehicle's trajectory relative to the one or more identified objects, calculating a time-to-collision between the highest threat object and the side surface of the vehicle, determining a remedial action by comparing the time-to-collision with at least one threshold, and initiating the remedial action to avoid a collision between the side surface of the vehicle and the highest threat object.

According to another embodiment of the invention, there is provided a method for use with a vehicle collision system that includes detecting one or more objects within a predetermined proximity along a vehicle's side surface(s), determining a potential for collision between the vehicle's side surface(s) and each of the one or more objects detected within the predetermined proximity, calculating a time-to-collision for each potential collision to identify which object has the lowest time-to-collision, and selectively initiating a remedial action to avoid collision between the vehicle side surface(s) and the object with the lowest time-to-collision.

According to yet another embodiment of the invention, there is provided a method for use with a vehicle collision system that includes receiving data from a plurality of sensors, identifying one or more object(s) in a field-of-view extending along a side surface of the vehicle based on the received data, calculating an expected vehicle path based on current vehicle trajectory, comparing the expected vehicle path with the one or more object(s) in the field-of-view to determine a potential for collision between the side surface(s) of the vehicle and the one or more object(s) in the field-of-view, calculating an estimated time-to-collision between the vehicle and the one or more detected object(s) in the field-of-view, determining a highest threat object based on the estimated times-to-collision, and comparing a time-to-collision for the highest threat object with a series of thresholds to selectively determine a remedial action to avoid the collision.

### DRAWINGS

One or more embodiments of the invention will hereinafter be described in conjunction with the appended drawings, wherein like designations denote like elements, and wherein:

FIG. 1 is a is a schematic view illustrating a host vehicle having an exemplary vehicle collision system; and

FIG. 2 is a schematic view illustrating representations of potential side collisions with another vehicle and with stationary objects;

FIG. 3 is another schematic view illustrating representations of potential side collisions with stationary objects in a parking scenario; and

FIG. 4 is a flowchart illustrating an exemplary method for use with a vehicle collision warning system, such as the exemplary system shown in FIG. 1.

### DESCRIPTION

The exemplary vehicle collision system and method described herein may be used to detect and avoid a potential or impending side collision with another vehicle or object. The method described below minimizes side collision with stationary or moving objects in relatively low speed and/or parking scenarios; for purposes of the present application, the term “low speed” means vehicle speeds of 30 mph or less. The disclosed vehicle collision system implements a method for detecting object(s) along the side surfaces of the vehicle and determines whether there is a potential for collision based on the vehicle's trajectory. Of the detected object(s), the system calculates a time-to-collision and determines which object poses the highest threat of collision based on the lowest time-to-collision. The lowest time-to-collision of the highest threat object is then compared to a plurality of thresholds to determine the most appropriate remedial action to avoid the collision.

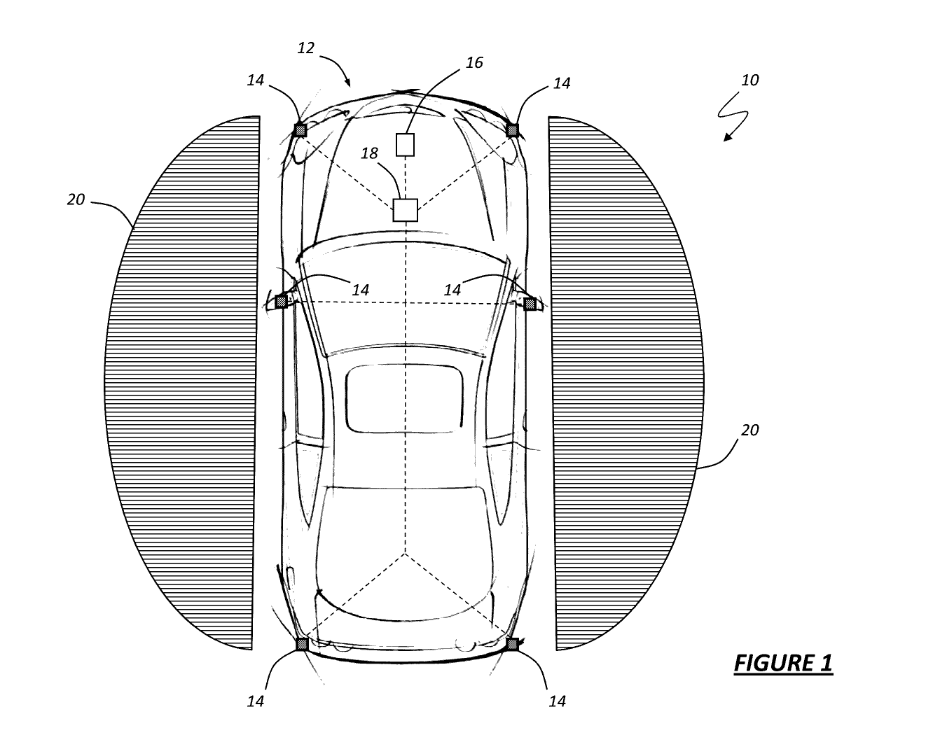

With reference to FIG. 1, there is shown a general and schematic view of an exemplary vehicle collision system 10 installed on a host vehicle 12. It should be appreciated that the present system and method may be used with any type of vehicle, including traditional vehicles, hybrid electric vehicles (HEVs), extended-range electric vehicles (EREVs), battery electrical vehicles (BEVs), motorcycles, passenger vehicles, sports utility vehicles (SUVs), cross-over vehicles, trucks, vans, buses, recreational vehicles (RVs), etc. These are merely some of the possible applications, as the system and method described herein are not limited to the exemplary embodiments shown in the Figures, and could be implemented in any number of different ways.

According to one example, vehicle collision system 10 employs object detection sensors 14, inertial measurement unit (IMU) 16, and a control module 18, which in one embodiment is an external object calculating module (EOCM). Object detection sensors 14 may be a single sensor or a combination of sensors, and may include without limitation, a light detection and ranging (LIDAR) device, a radio detection and ranging (RADAR) device, a vision device (e.g., camera, etc.), a laser diode pointer, or a combination thereof. In addition to simply detecting the presence of objects, object detection sensors 14 may also be used, either alone or in conjunction with other sensors, to determine the distance between the detected objects and the vehicle 12. A camera could also be used in conjunction with such sensors. Collision system 10 is not limited to any particular type of sensor or sensor arrangement, specific technique for gathering or processing sensor readings, or particular method for providing sensor readings, as the embodiments described herein are simply meant to be exemplary.

Any number of different sensors, components, devices, modules, systems, etc. may provide vehicle collision warning system 10 with information or input that can be used by the present method. It should be appreciated that object detection sensors 14, as well as any other sensor located in and/or used by collision system 10 may be embodied in hardware, software, firmware, or some combination thereof. These sensors may directly sense or measure the conditions for which they are provided, or they may indirectly evaluate such conditions based on information provided by other sensors, components, devices, modules, systems, etc. Furthermore, these sensors may be directly coupled to control module 18, indirectly coupled via other electronic devices, a vehicle communications bus, network, etc., or coupled according to some other arrangement known in the art. These sensors may be integrated within another vehicle component, device, module, system, etc. (e.g., sensors integrated within an engine control module (ECM), traction control system (TCS), electronic stability control (ESC) system, antilock brake system (ABS), etc.), or they may be stand-alone components (as schematically shown in FIG. 1). It is possible for any of the various sensor readings to be provided by some other component, device, module, system, etc. in vehicle 12 instead of being directly provided by an actual sensor element. In some instances, multiple sensors might be employed to sense a single parameter (e.g., for providing signal redundancy). It should be appreciated that the foregoing scenarios represent only some of the possibilities, as any type of suitable sensor arrangement may be used by collision system 10. That system is not limited to any particular sensor or sensor arrangement.

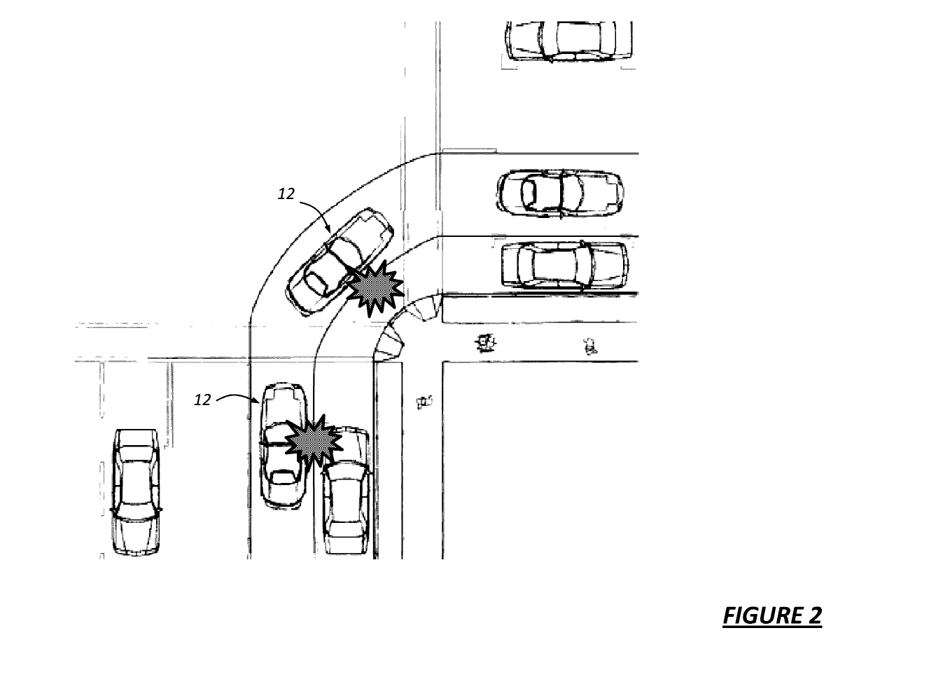

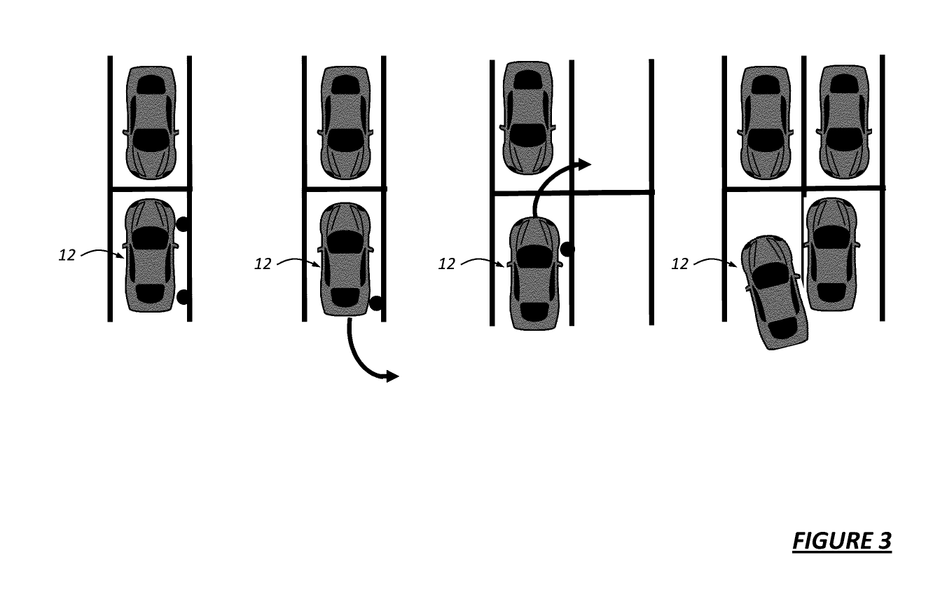

As shown in FIG. 1, object detection sensors 14 may be located in the side-vehicle mirrors, front vehicle bumpers, and/or rear vehicle bumpers. While not shown, object detection sensors 14 may also be placed in the vehicle doors. One of ordinary skill in the art appreciates that while six object detection sensors 14 are illustrated in FIG. 1, the number of sensors required may vary depending on the type of sensor and vehicle. Regardless of the position or the number of sensors used, object detection sensors 14 are calibratable and configured to create a field-of-view 20 that extends from a front end of the vehicle to a back end of the vehicle and outwardly from each side of the vehicle 12. In this way, vehicle collision system 10 is able to detect and prevent side collisions with various objects as shown in FIGS. 2 and 3. For example, FIG. 2 illustrates graphical representations of potential side collisions with another vehicle and with stationary objects such as curbs, fire hydrants, pedestrians, poles, etc. as the host vehicle 12 is turning a corner. Similarly, FIG. 3 illustrates examples of potential side collisions in low speed parking scenarios wherein the host vehicle 12 is backing out of, or otherwise maneuvering, out of a parking stall. The term “objects” should be broadly construed to include any objects that are detectable in the field-of-view 20, including other vehicles.

IMU 16 is an electronic device that measures and reports a vehicle's velocity, orientation, and gravitational forces using a combination of accelerometers and gyroscopes, sometimes also magnetometers. IMU 16 works by detecting a current rate of acceleration using one or more accelerometers and detects changes in rotational attributes like pitch, roll, and yaw using one or more gyroscopes. Some also include a magnetometer, mostly to assist calibration against orientation drift. Angular accelerometers measure how the vehicle is rotating in space. Generally, there is at least one sensor for each of the three axes: pitch (nose up and down), yaw (nose left and right) and roll (clockwise or counter-clockwise from the vehicle cockpit). Linear accelerometers measure non-gravitational accelerations of the vehicle. Since it can move in three axes (up & down, left & right, forward & back), there is a linear accelerometer for each axis. A computer continually calculates the vehicle's current position. First, for each of the six degrees of freedom (x,y,z and θₓ, θ_{y} and θ_{z}), it integrates over time the sensed acceleration, together with an estimate of gravity, to calculate the current velocity. Then it integrates the velocity to calculate the current position.

Control module 18 may include any variety of electronic processing devices, memory devices, input/output (I/O) devices, and/or other known components, and may perform various control and/or communication related functions. Depending on the particular embodiment, control module 18 may be a stand-alone vehicle electronic module (e.g., an object detection controller, a safety controller, etc.), it may be incorporated or included within another vehicle electronic module (e.g., a park assist control module, brake control module, etc.), or it may be part of a larger network or system (e.g., a traction control system (TCS), electronic stability control (ESC) system, antilock brake system (ABS), driver assistance system, adaptive cruise control system, lane departure warning system, etc.), to name a few possibilities. Control module 18 is not limited to any one particular embodiment or arrangement.

For example, in an exemplary embodiment control module 18 is an external object calculating module (EOCM) that includes an electronic memory device that stores various sensor readings (e.g., inputs from object detection sensors 14 and position, velocity, and/or acceleration readings from IMU 16), look up tables or other data structures, algorithms, etc. The memory device may also store pertinent characteristics and background information pertaining to vehicle 12, such as information relating to stopping distances, deceleration limits, temperature limits, moisture or precipitation limits, driving habits or other driver behavioral data, etc. EOCM 18 may also include an electronic processing device (e.g., a microprocessor, a microcontroller, an application specific integrated circuit (ASIC), etc.) that executes instructions for software, firmware, programs, algorithms, scripts, etc. that are stored in the memory device and may govern the processes and methods described herein. EOCM 18 may be electronically connected to other vehicle devices, modules and systems via suitable vehicle communications and can interact with them when required. These are, of course, only some of the possible arrangements, functions and capabilities of EOCM 18, as other embodiments could also be used.

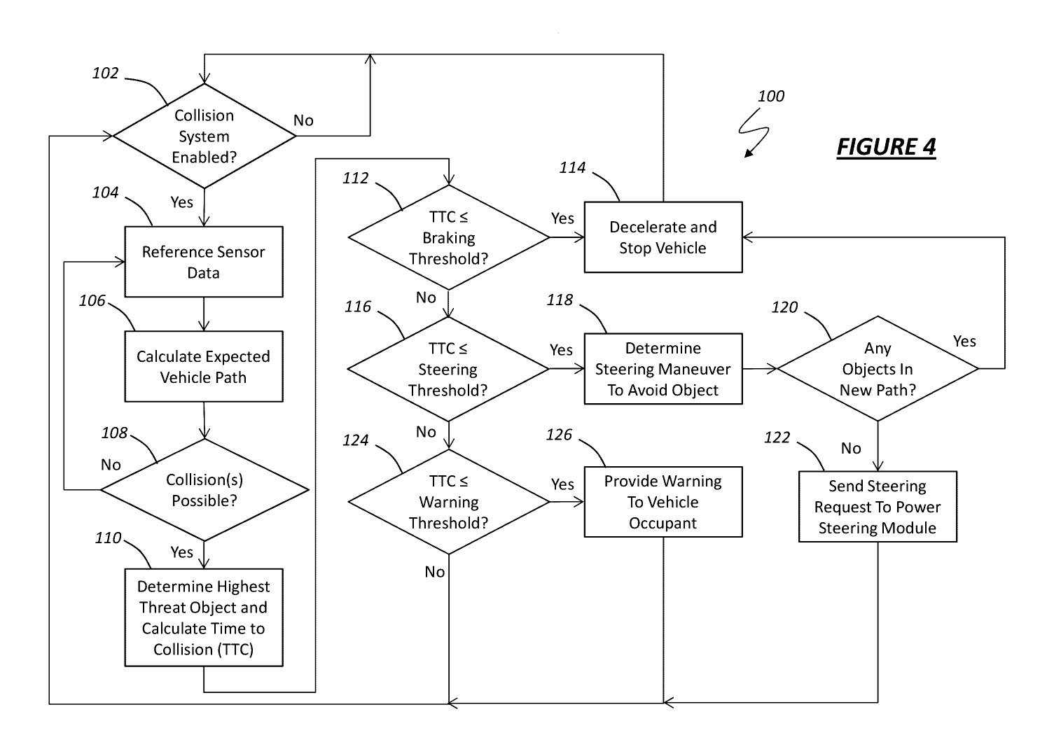

Turning now to FIG. 4, there is shown an exemplary method 100 that may be used with vehicle collision system 10 to detect and avoid a potential or impending side collision with an object or other vehicle. Beginning with step 102, the system 10 determines whether the collision system 10 is enabled. The enablement of the collision system 10 depends on varying criteria, including, but not limited to, the vehicle ignition being in an on position. At step 104 the system via EOCM 18 references sensor data from at least object detection sensors 14 to determine if objects or other vehicles are detected within the field-of-view 20 on both sides of the vehicle 12. At step 106, the vehicle's expected path is calculated based on data received from various vehicle components, such as, for example, the IMU 16, the throttle pedal sensor, the brake pedal sensor, and the steering wheel angle sensor. At step 108, preliminary assessments are made to determine the potential for side collisions with the detected objects. In one embodiment, the assessments include course estimates regarding the vehicle's expected path and the current position of the detected objects. Based on these course estimates, the system determines whether a potential for a side collision exists between the vehicle 12 and the detected objects. If there is no potential for a side collision with any of the detected objects, the process returns to referencing the sensor data at step 104. If there is a potential for a side collision with any of the detected objects, at step 110 the system initiates a preliminary threat assessment by determining which of the detected objects poses the highest threat for a side collision and calculates a time-to-collision between the vehicle and the highest threat object. In one embodiment, the highest threat object is the object having the lowest time-to-collision. In words, the first object that is likely to collide with the side surface of the vehicle based on the relationship between the position, movement, and trajectory of both the vehicle 12 and the detected object.

At step 112, the time-to-collision for the highest threat object is compared to a braking action threshold. If the time-to-collision for the highest threat object is less than or equal to the braking action threshold, at step 114 a command to decelerate and stop the vehicle is sent to an electronic brake control module (not shown). In one embodiment, the rate of deceleration is determined based on current sensor readings and/or a calibration table stored in the EOCM 18 or the brake control module. Thereafter, the process returns to step 102 to continually check if the remedial action and/or external conditions have changed. If the time-to-collision for the highest threat object at step 112 is not less than or equal to the braking action threshold, at step 116 the time-to-collision for the highest threat object is compared to a steering action threshold.

If the time-to-collision for the highest threat object is less than or equal to the steering action threshold, at step 118 the system determines a steering maneuver to avoid the collision with the highest threat object. The steering maneuver is determined in part based on the relationship between the position, movement, and trajectory of both the vehicle 12 and the detected object. In one embodiment, step 118 may also include sending a brake pulse command as a haptic indicator to the driver prior to commanding the steering maneuver. Prior to initiating the calculated steering maneuver, at step 120 the system evaluates the vehicle's new trajectory to determine if any objects are in the new path of the vehicle 12. If there are objects in the new path that continue to pose a potential for collision, the process returns to step 114 and initiates an emergency braking feature by sending a command to the electronic brake control module to decelerate and stop the vehicle. If there are no objects in the new path, then at step 122 a steering request command is sent to a power steering module (not shown) to execute the steering maneuver to avoid the collision. Thereafter, the process returns to step 102 to continually check if the remedial action and/or external conditions have changed.

Referring back to step 116, if the time-to-collision for the highest threat object is not less than or equal to the steering action threshold, at step 124 the time-to-collision for the highest threat object is compared to a warning action threshold. If the time-to-collision for the highest threat object is less than or equal to the warning action threshold, at step 126 an alert is sent to the instrument panel cluster (not shown) warning the vehicle occupants of the potential collision. The alert can be, without limitation, a message via the instrument panel cluster, audible alerts, haptic alerts, and/or brake pulses.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for use with a vehicle collision system, the method comprising the steps of:
identifying one or more stationary objects along a side surface of the vehicle;
determining a highest threat object based on the vehicle's trajectory relative to the one or more identified stationary objects;
calculating a time-to-collision between the highest threat object and the side surface of the vehicle;
determining a remedial action by comparing the time-to-collision with at least one threshold; and
initiating the remedial action to avoid a collision between the side surface of the vehicle and the highest threat object.

2. The method of claim 1, wherein the one or more stationary objects are detected in a field-of-view that extends from a front end of the vehicle to a back end of the vehicle and outwardly from each side of the vehicle.

3. The method of claim 1, further comprising receiving data measured from a plurality of sensors, wherein the measured data relates to the one or more stationary objects detected in a field-of-view along the side surface of the vehicle.

4. The method of claim 1, wherein the step of determining the highest threat object further comprises initiating a preliminary threat assessment, which includes calculating an estimated time-to-collision based on an estimated vehicle trajectory for each of the one or more stationary objects identified along the side surface of the vehicle, wherein the highest threat object is the object having the lowest estimated time-to-collision.

5. The method of claim 1, wherein the at least one threshold includes a braking action threshold, a steering action threshold, and a warning action threshold.

6. The method of claim 4, wherein the step of determining the remedial action further includes sequentially comparing the time-to-collision for the highest threat object with the braking action threshold, the steering action threshold, and the warning action threshold, and wherein the severity of the remedial action varies depending on the time-to-collision.

7. The method of claim 6, wherein the step of initiating the remedial action further comprises sending a command configured to decelerate and stop the vehicle if the time-to-collision is less than or equal to the braking action threshold.

8. The method of claim 7, wherein the step of initiating the remedial action further comprises comparing the time-to-collision to the steering action threshold if the time-to-collision is greater than the braking action threshold, and determining a steering maneuver to avoid the highest threat object if the time-to-collision is less than or equal to the steering action threshold.

9. The method of claim 8, further comprising determining whether there is a potential for collision with any objects in the vehicle's new trajectory created by the steering maneuver used to avoid the highest threat object.

10. The method of claim 8, wherein the step of initiating the remedial action further comprises comparing the time-to-collision to the warning action threshold if the time-to-collision is greater than the steering action threshold, and providing a warning to vehicle occupants if the time-to-collision is less than or equal to the warning action threshold.

11. A method for use with a vehicle collision system, the method comprising the steps of:
detecting one or more objects within a predetermined proximity along a vehicle's side surface(s);
determining a potential for collision between the vehicle's side surface(s) and each of the one or more objects detected within the predetermined proximity;
calculating a time-to-collision for each potential collision to identify which object has the lowest time-to-collision; and
selectively initiating a remedial action to avoid collision between the vehicle side surface(s) and the object with the lowest time-to-collision.

12. The method of claim 11, wherein the predetermined proximity is a field-of-view that extends from a front end of the vehicle to a back end of the vehicle and outwardly from each side of the vehicle.

13. The method of claim 11, wherein the step of selectively initiating a remedial action further comprises selecting a remedial action by comparing the lowest time-to-collision with at least one threshold.

14. The method of claim 11, wherein the step of selectively initiating a remedial action further comprises sequentially comparing the lowest time-to-collision with a braking action threshold, a steering action threshold, and a warning action threshold.

15. The method of claim 14, wherein the step of selectively initiating a remedial action further comprises sending a command configured to decelerate and stop the vehicle if the lowest time-to-collision is less than or equal to the braking action threshold.

16. The method of claim 15, wherein the step of initiating a remedial action further comprises comparing the lowest time-to-collision to the steering action threshold if the lowest time-to-collision is greater than the braking action threshold, and determining a steering maneuver to avoid the collision with the lowest time-to-collision object if the lowest time-to-collision is less than or equal to the steering action threshold.

17. The method of claim 16, further comprising determining whether there is a potential for collision with any objects in the vehicle's new trajectory created by the steering maneuver used to avoid the collision with the lowest time-to-collision object.

18. The method of claim 17, wherein the step of initiating the remedial action further comprises comparing the lowest time-to-collision to the warning action threshold if the time-to-collision is greater than the steering action threshold, and providing a warning to vehicle occupants if the lowest time-to-collision is less than or equal to the warning action threshold.

19. A method for use with a vehicle collision system, the method comprising the steps of:
receiving data from a plurality of sensors;
identifying one or more object(s) in a field-of-view extending along a side surface of the vehicle based on the received data;
calculating an expected vehicle path based on current vehicle trajectory;
comparing the expected vehicle path with the one or more object(s) in the field-of-view to determine a potential for collision between the side surface(s) of the vehicle and the one or more object(s) in the field-of-view;
calculating an estimated time-to-collision between the vehicle and the one or more detected object(s) in the field-of-view;
determining a highest threat object based on the estimated times-to-collision; and
comparing a time-to-collision for the highest threat object with a series of thresholds to selectively determine a remedial action to avoid the collision.

20. The method of claim 19, selectively determining the remedial action further comprises:
initiating a braking command if the time-to-collision for the highest threat object is less than or equal to a braking action threshold;
initiating a steering maneuver to avoid the collision if the time-to-collision for the highest threat object is greater than the braking action threshold and less than or equal to a steering action threshold; and
initiating a warning to vehicle occupants if the time-to-collision for the highest threat object is greater than the steering action threshold and less than or equal to a warning action threshold.

21. A vehicle collision system, the system comprising:
a plurality of sensors configured to identify one or more stationary objects along a side surface of the vehicle; and
a control module configured to:
determine a highest threat object based on the vehicle's trajectory relative to the one or more identified stationary objects;
calculate a time-to-collision between the highest threat object and the side surface of the vehicle;
determine a remedial action by comparing the time-to-collision with at least one threshold; and
initiate the remedial action to avoid a collision between the side surface of the vehicle and the highest threat object.
